(19) United States
(12) Patent Application Publication
(10) Pub. No.: US 2011/0249742 A1
(43) Pub. Date: Oct. 13, 2011

(54) COUPLED VIDEO PRE-PROCESSOR AND CODEC INCLUDING REFERENCE PICTURE FILTER THAT MINIMIZES CODING EXPENSE DURING PRE-PROCESSING MODE TRANSITIONS

(75) Inventors: Douglas PRICE, San Jose, CA (US); Xiaosong ZHOU, Campbell, CA (US); Hsi-Jung WU, San Jose, CA (US)

(73) Assignee: APPLE INC., Cupertino, CA (US)

(21) Appl. No.: 12/756,073

(22) Filed: Apr. 7, 2010

(51) Int. Cl. H04N 7/32

(52) U.S. Cl. 375/240.16; 375/E07.123

(57) ABSTRACT

A video coding system includes a coding engine operable to code source video according to motion compensated prediction techniques, a reference picture cache to store decoded picture data of previously-coded reference pictures, and a programmable filter to apply selected filtering operation(s) to picture data retrieved from the reference picture cache and provided to the coding engine. A video decoding system includes a decoding engine operable to decode coded video data, a reference picture cache to store decoded picture data of previously-decoded reference pictures, and a programmable filter to apply a filtering operation to picture data retrieved from the reference picture cache and provided to the decoding engine as determined by the coded video data. Video coding/decoding systems so configured may avoid coding costs that can be incurred when a pre-processing filter switches pre-processing modes within source data in a manner that causes divergence between stored reference pictures and video pictures input to the coding engine.

### BACKGROUND

The present disclosure relates to video coding.

Modern video coding systems operate according to pre-defined protocols to perform reversible video compression operations. The video encoder performs a variety of different processing operations on source video to reduce redundancy of the source video and thereby reduce its bandwidth. The video encoder selects different coding modes (for example, intra or inter coding modes) and coding parameters. At the conclusion of the video coding operations, the video coder generates a coded video data signal that includes coded video content and the mode/parameter selections that the video coder used to generate the coded video. It outputs the coded video signal to a decoder as channel data. A decoder parses the channel data. From the mode/parameter identifiers, it identifies processing operations performed by the encoder and it performs inverting operations to reverse the coding operations. The decoder may generate a recovered video signal, which can be rendered on a display device. The decoder can perform its operations when the encoder and decoder operate according to a common coding protocol.

Many video coding systems engage in pre-processing and post-processing operations that are not coded expressly in channel data or specified by any protocol. Encoders often apply pre-processing techniques to the source pictures to improve compression efficiency of the video coding process or to improve the visual quality of the coded bit stream. The pre-processing techniques are often selected with the encoder specifications in mind, but they typically are not tightly coupled with the processes internal to the encoder. As a result, if pre-processing is not carefully applied, they may induce an encoder to output coded video data at a higher bit rate than optimal because improperly applied pre-processing can reduce temporal redundancy of video for prediction purposes.

A wide variety of pre-processing algorithms are known for video coding systems. Some video coders may select between the algorithms (or even blend application of different algorithms) in response to content of source video. As the content of the source video changes, so can the preprocessing algorithms that are applied to it. Switching among different pre-processing algorithms can have a consequence for the efficiency of video coders because previously-coded video, which may have been subject to a different array of pre-processing algorithms, may lose correlation to later-received video that needs to be coded. Temporal predictive techniques may not be as efficient as they otherwise might be if pre-processing operations change over time; reference pictures that otherwise might be good sources of prediction may lose correlation to later-received video due to the effects of disparate pre-processing.

### BRIEF DESCRIPTION OF THE DRAWINGS

FIG. 1 is a block diagram of a video coding/decoding system according to an embodiment of the present invention.

FIG. 2 is a simplified block diagram of a video coding system according to an embodiment of the present invention.

FIG. 3 illustrates a method according to an embodiment of the present invention.

FIG. 4 illustrates a method according to another embodiment of the present invention.

FIG. 5 is a block diagram of a coding engine according to an embodiment of the present invention.

FIG. 6 is a simplified block diagram of a video decoding system according to an embodiment of the present invention.

### DETAILED DESCRIPTION

Embodiments of the present invention may provide a video coding system that includes a coding engine operable to code source video according to motion compensated prediction techniques, a reference picture cache to store decoded picture data of previously-coded reference pictures, and a programmable filter to apply selected filtering operation(s) to picture data retrieved from the reference picture cache and provided to the coding engine. Embodiments of the present invention further may provide a video decoding system that includes a decoding engine operable to decode coded video data according to motion compensation techniques, a reference picture cache to store decoded picture data of previously-decoded reference pictures, and a programmable filter to apply a filtering operation to picture data retrieved from the reference picture cache and provided to the decoding engine. Video coding/decoding systems so configured may avoid coding costs that otherwise might be incurred when a pre-processing filter switches among pre-processing modes in a manner that causes divergence between stored reference pictures and video pictures input to the coding engine.

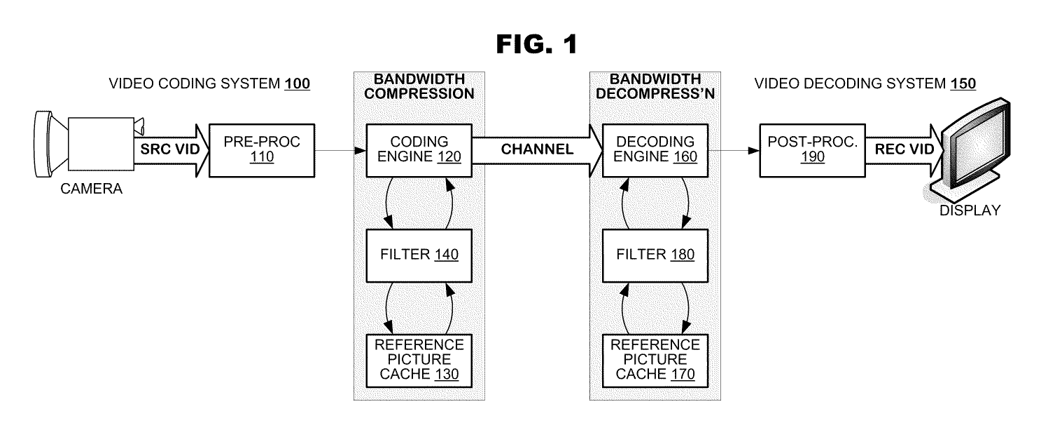

FIG. 1 illustrates a video coding system 100 and a video decoding system 150 according to an embodiment of the present invention. The video coding system 100 may include a pre-processor 110, a coding engine 120, a reference picture cache 130 and a filtering unit 140. The pre-processor 110 may perform processing operations on pictures of a source video sequence to condition the pictures for coding. The coding engine 120 may code the video data according to a predetermined coding protocol. The coding engine 120 may output coded data representing coded pictures, as well as data representing coding modes and parameters selected for coding the pictures, to a channel. The reference picture cache 130 may store decoded data of reference pictures previously coded by the coding engine; the picture data stored in the reference picture cache 130 may represent sources of prediction for later-received pictures input to the video coding system 100. The filtering unit 140 may be a programmable unit that applies selected filtering operation(s) to picture data retrieved from the reference picture cache 130 during operation of the coding engine 120. During operation, the filtering unit 140 may apply filtering to retrieved reference picture data to improve correlation between the retrieved reference picture data and a source picture being coded by the coding engine 120.

The video decoding system 150 may include a decoding engine 160, a reference picture cache 170, a filtering unit 180 and a post-processor 190. The decoding engine 160 may parse coded video data received from the encoder and perform decoding operations that recover a replica of the source video sequence. The reference picture cache 170 may store decoded data of reference pictures previously decoded by the decoding engine 120, which may be used as prediction references for other pictures to be recovered from later-received coded video data. The filtering unit 180 may be a programmable unit that applies selected filtering operations picture data retrieved from the reference picture cache 170 during operation of the decoding engine 160. The filtering operations may be specified by channel data received from the encoder 100. During operation the filtering unit 170 may apply filtering to retrieved reference picture data corresponding to filtering applied at the video coding system 100. The post-processor 190 may further condition the recovered video data for rendering on a display device.

In an embodiment, the channel may be a wired communication channel as may be provided by a communication network or computer network. Alternatively, the communication channel may be a wireless communication channel exchanged by, for example, satellite communication or a cellular communication network. Still further, the channel may be embodied as a storage medium including, for example, magnetic, optical or electrical storage devices.

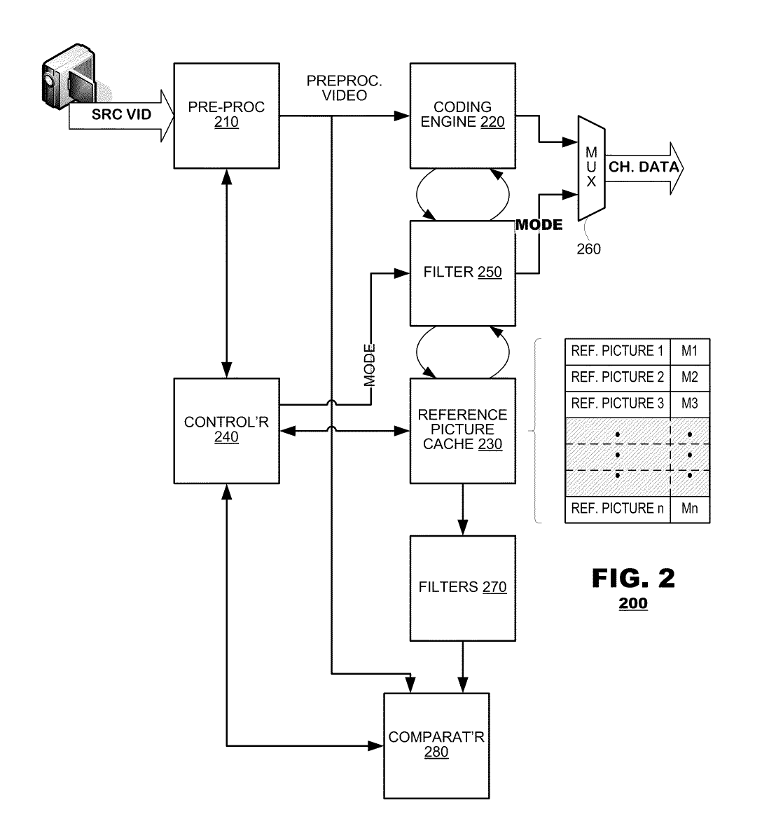

FIG. 2 is a simplified block diagram of a video coding system 200 according to an embodiment of the present invention. The video coding system 200 may include a pre-processor 210, a coding engine 220 and a reference picture cache 230. The pre-processor 210 may perform processing operations on a source video sequence input to the video coding system 200 to condition the source video sequence for coding by the coding engine 220. For example, the pre-processor 210 may perform filtering operations or other pre-processing operations on the source video sequence, which may normalize visual artifacts in the source video sequence. The coding engine 220 may perform coding operations on the pre-processed video sequence to reduce bandwidth of the video sequence. For example, the coding engine 220 may code the video sequence according spatial and/or temporal prediction, which reduces bandwidth of the video sequence. In doing so, the coding engine 220 may refer to recovered data of previously-coded pictures (called “reference pictures” herein) from the video sequence as sources of prediction for later-coded pictures. Operation of the coding engine 220 and reference picture cache 230 may proceed according to the syntax of the well-known coding standards, such as the H.263 and H.264 families of standards promulgated by the International Telecommunication Union of Geneva, Switzerland.

During operation, the coding engine 220 may select dynamically coding parameters for video, such as selection of reference pictures, computation of motion vectors and selection of quantization parameters, which are transmitted to a decoder (not shown) as part of channel data; selection of coding parameters may be performed by a coding controller, represented by controller 240 in FIG. 1. Similarly, selection of pre-processing operation(s) to be performed on the source video may change dynamically in response to changes in the source video. Such selection of pre-processing operations may be administered by a control function, also represented as the controller 240 of FIG. 1.

As noted, the reference picture cache 230 may store decoded video data of a predetermined number n of reference pictures (for example, n=16). The reference pictures may have been previously coded by the coding engine 220 then decoded and stored in the reference picture cache 230. Many coding operations are lossy processes, which cause decoded pictures to be imperfect replicas of the source pictures that they represent. By storing decoded reference pictures in the reference picture cache, the video coding system 200 may store recovered video as it will be obtained by a decoder (not shown) when the channel data is decoded; for this purpose, the coding engine 220 may include a video decoder (not shown) to generate recovered video data from coded reference picture data. In an embodiment, the reference picture cache may store metadata identifiers M1-Mn that indicate, for each stored reference picture, the preprocessing filter(s) that were applied to the corresponding source video pictures when the reference picture was coded.

During operation, as characteristics of the source video data change, different pre-processing operations may be applied to the source video data in response to those changes. When selecting a reference picture to be used as a source of prediction for a new picture in the source video sequence, the coding engine controller 240 may compare the pre-processing filter(s) that were applied to the source video picture to the pre-processing filter(s) that are identified by the respective metadata identifiers M1-Mn. If the comparison identifies a match, the controller 240 may select a matching reference picture as a source of prediction. In another embodiment, a controller 240 may select a reference picture based on a variety of factors (most often, similarity in image data is a primary criterion); in such a system, a match between pre-processing filters may be included as an additional factor to be included in the controller's calculus and selection of reference picture.

The video coding system 200 further may include a programmable filter 250 provided between the reference picture cache 230 and the coding engine 220, according to an embodiment of the present invention. During operation, as characteristics of the source video data change and different pre-processing operations are applied to the source video data in response to those changes, a controller may filter stored reference picture data to be applied during coding. Filter 250 represents filtering operations that may be applied to the stored data in the reference picture cache 230 once an appropriate filtering algorithm is identified.

In one embodiment, where metadata identifiers M1-Mn identify preprocessing filter(s) that were applied when the reference pictures were coded, a controller 240 may apply a first filtering operation to invert effects of preprocessing identified by the metadata identifier. Although many filters are lossy processes, some filters tend to invert processes of other filters. For example, a blur filter tends to reverse effects of a sharpening filter and a sharpening filter tends to invert effects of a blur filter. For purposes of the present discussion, a filter that tends to reverse the effects of another filter is considered its “inverse.” In another embodiment, an encoder may retain a copy of a source picture corresponding to the stored reference picture. The encoder may identify a filtering operation to be performed on the reference picture that causes the filtered reference picture to most closely resemble the source picture. Such a filtering operation also may be considered an “inverse” of an originally-applied filtering operation for purposes of the present discussion.

Having found an inverse filtering operation, the controller 240 further may apply a second filtering operation corresponding to the filtering applied to a source picture currently being processed by the coding engine 220. The first and second filtering operations may be applied by the filter 250. In so doing, the filter 250 should provide to the coding engine 220 a processed reference picture that more closely resembles the source picture being coded than would be provided if the reference picture were output directly to the coding engine 220 without filtering. Accordingly, the processed reference picture should be a better source of prediction than an unfiltered reference picture, which improves overall coding efficiency. Having selected operations of the first and second filtering operations, the controller may cause an identifier of these filtering operations to be provided in the channel data (identified as filtering “mode” in FIG. 1). The filtering operations, therefore, may be used by a decoder to perform corresponding filtering operations on the stored reference pictures during decoding operations. FIG. 1 includes a multiplexer (MUX) 260 to illustrate merger of the mode identifiers into channel data for transmission to a decoder.

In another embodiment, a controller 240 may search for a set of filtering operations without use of stored metadata. In this embodiment, the video coding system 200 is illustrated as including a filter bank 270 and comparators 280 to perform a search operation. In this embodiment, the controller 260 may apply a variety of filtering operations to each of the pictures stored in the reference picture cache via filter bank 270. Having filtered each of the pictures, the controller may compare (280) the filtered reference picture data to the source picture to determine which filtering operation generates video data that is a closest match to the source picture. Having found a filtered reference picture that generates a closest match, the controller 240 may cause the coding engine 220 to code the source picture using the filtered reference picture that generates a closest match (via the path of filter 250). In this embodiment, the filter 250 may output a filtering mode identifier to the channel data that identifies a filtering operation applied to the reference picture prior to coding.

In yet another embodiment of the present invention, an encoder may store source pictures corresponding to reference pictures stored in the reference picture cache (storage not shown). When coding a new source picture that has been pre-processed by a new pre-processing configuration, an encoder may apply similar pre-processing operations to the stored source pictures that correspond to the reference pictures. Thus, the source picture to be coded and the already-coded source pictures corresponding to the reference pictures will be pre-processed according to the same techniques. Thereafter, the encoder may apply various filtering operations to the stored reference pictures, which are recovered replicas of the already-coded source pictures, to identify a filtering operation that most closely approximates the results obtained by pre-processing the already coded source pictures. When a best match is found, the coding engine may code the new source picture with reference to the stored reference picture and filtering operation that generated the best match. The coding engine further may output a mode identifier to the channel corresponding to the selected filtering operation.

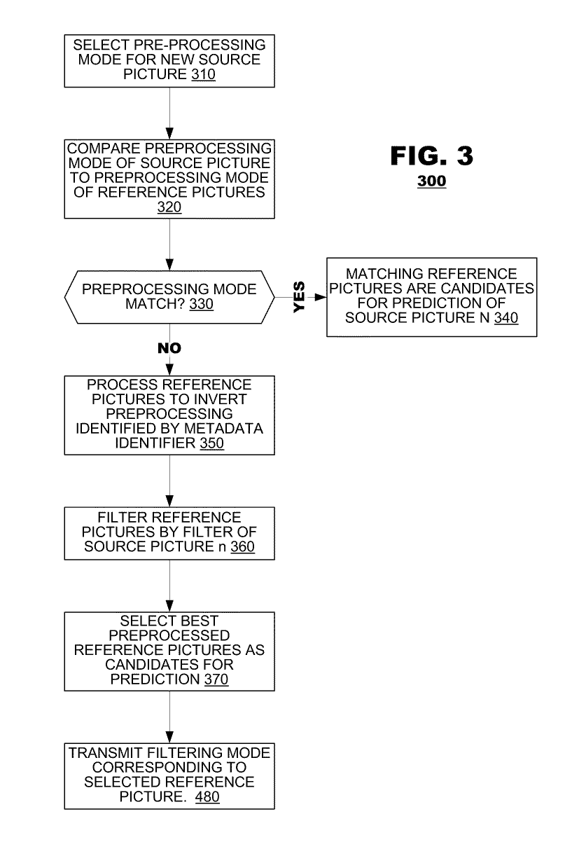

FIG. 3 illustrates a method 300 according to an embodiment of the present invention. According to the method, a video coder may select a pre-processing filtering mode to be applied to a new picture of the source video sequence (box 310). The video coder may compare the pre-processing mode of the source picture to modes previously applied to stored reference pictures (box 320). The video coder may determine if the comparison identifies a match (box 330). If so, the matching reference picture(s) may be identified as candidates for prediction of the new source picture (box 340).

If no match is identified, the video coder may perform filtering upon the stored reference pictures to invert filtering operations identified by respective metadata identifiers (box 350). The video coder further may apply filtering to the processed reference pictures corresponding to the filtering applied to the source picture (box 360). Thereafter, the video coder may select a processed reference picture that is a best fit to the pre-processed source picture as a candidate for prediction (box 370). The video coder may transmit a mode identifier in the channel data identifying a filtering mode applied to the selected reference picture (box 480).

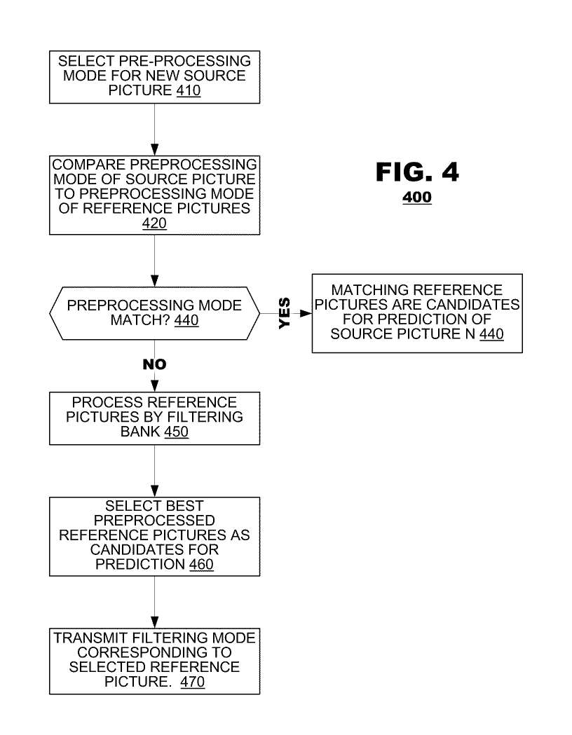

FIG. 4 illustrates a method 400 according to another embodiment of the present invention. According to the method, a video coder may select a pre-processing filtering mode to be applied to a new picture of the source video sequence (box 410). The video coder may compare the pre-processing mode of the source picture to modes previously applied to stored reference pictures (box 420). The video coder may determine if the comparison identifies a match (box 430). If so, the matching reference picture(s) may be identified as candidates for prediction of the new source picture (box 440).

If no match is identified, the video coder may perform filtering upon the stored reference pictures for a variety of different filtering algorithms (box 450). Thereafter, the video coder may select a processed reference picture that is a best fit to the pre-processed source picture as a candidate for prediction (box 460). The video coder may transmit a mode identifier in the channel data identifying a filtering mode applied to the selected reference picture (box 470).

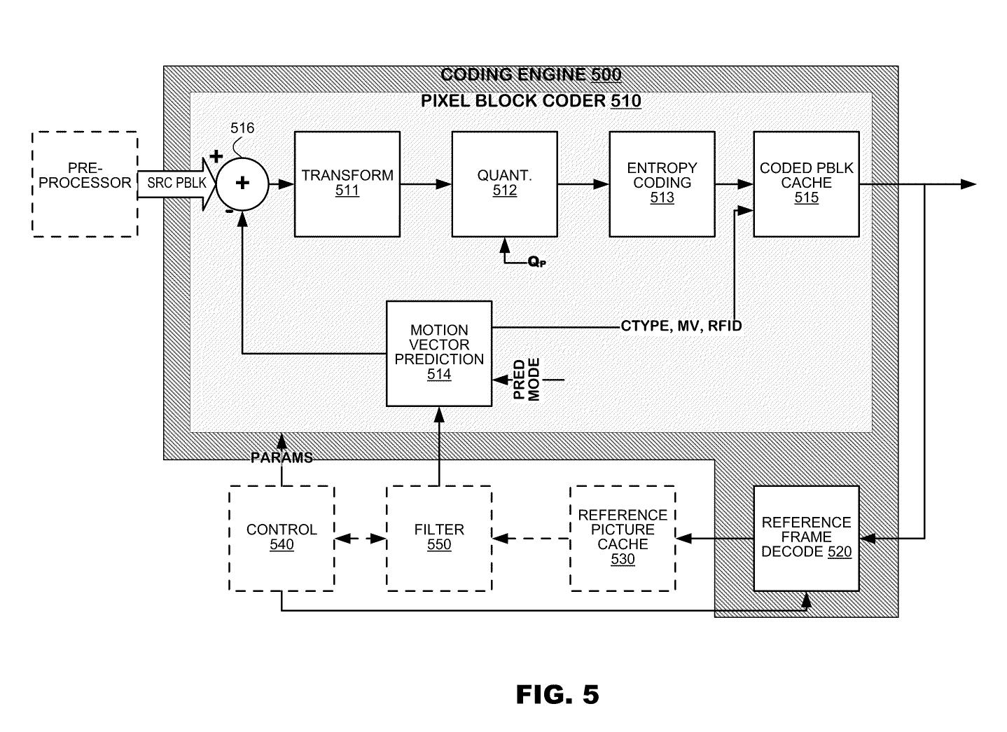

FIG. 5 is a simplified functional block diagram of a coding engine 500 according to an embodiment of the present invention. The coding engine 500 may code source video on a picture-by-picture basis and, within each picture, on a pixel block-by-pixel block basis. “Pixel blocks” represent regular arrays of video data, commonly 16 pixels by 16 pixels or 8 pixels by 8 pixels. The coding engine 500 may include a pixel block coder 510 that may code input pixel blocks into coded pixel blocks. The pixel block encoder 510 may include a transform unit 511, a quantizer unit 512, an entropy coder 513, a motion vector prediction unit 514, a coded pixel block cache 515, and a subtractor 516. The transform unit 511 may convert input pixel block data into an array of transform coefficients, for example, by a discrete cosine transform (DCT) process or a wavelet process. The quantizer unit 512 may decimate transform coefficients based on a quantization parameter. The quantization parameter may be output to the channel when the pixel block is coded. The entropy coder 513 may code the resulting truncated transform coefficients by run-value, run-length or similar entropy coding techniques. Thereafter, the coded pixel blocks may be stored in a cache 515. Eventually, coded pixel blocks may be output to the coded video data buffer 530 where they are merged with other elements of the coded video data and output to the channel.

The coding engine 500 also may include a reference picture decoder 520 provided in communication with the reference picture cache 530. During operation, the controller 540 may designate certain pictures as reference pictures to be used as prediction references for other pictures. The operations of the pixel block encoder 510 can introduce data losses and, therefore, the reference picture decoder 520 may decode coded video data of each reference picture to obtain a copy of the reference picture as it would be generated by a decoder (not shown). The decoded reference picture may be stored in the reference picture cache 530. When coding other pictures, a motion vector prediction unit 514 may retrieve pixel blocks from the reference picture cache 530 according to motion vectors (“mvs”) and supply them to a subtractor for comparison to the pixel blocks of the source video. In some coding modes, for example intra coding modes, motion vector prediction is not used. In inter coding modes, by contrast, motion vector prediction is used and the pixel block encoder outputs motion vectors identifying the source pixel block(s) used at the subtractor 516. In an embodiment of the present invention, the motion vector predictor 514 may receive pixel blocks from the reference picture cache 530 having been filtered by a programmable filter 550 as configured by the controller 540.

During operation, a video encoder 500 may operate according to a coding policy that selects picture coding parameters to achieve predetermined coding requirements. For example, a coding policy may select coding parameters to meet a target bit rate for the coded video data and to balance parameter selections against estimates of coding quality. A controller 540 may configure operation of the coding engine 500 according to the coding policy via coding parameter selection (params) such as coding type, quantization parameters, motion vectors, and reference picture identifiers. Additionally, the controller 540 may configure the filter 550 to condition pictures stored in the reference picture cache for prediction. Each combination of parameter selections can be considered a separate coding “mode” for the purposes of the present discussion. The controller 540 may monitor performance of the coding engine 500 to code various portions of the input video data and may cause video data to be coded, decoded and re-coded according to the various embodiments of the invention as discussed herein. Thus, the coding engine 500 is shown as a recursive coding engine.

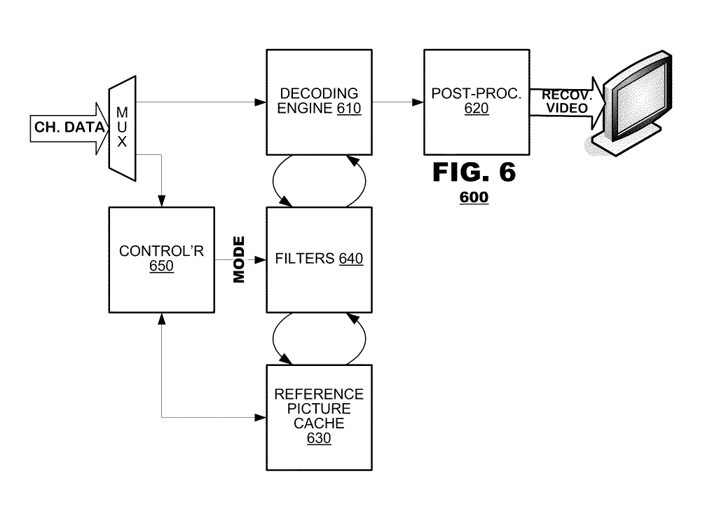

FIG. 6 is a simplified block diagram of a video decoding system according to an embodiment of the present invention. The video decoding system 600 may include a decoding engine 610, a post-processor, a reference picture cache 630 and a programmable filter 640, provided under control of a controller 650. The decoding engine 610 may generate a recovered video sequence from channel data received from an encoder (not shown). In so doing, the decoding engine 610 may parse the channel data to identify prediction modes applied to coded pixel blocks and invert coding processes that were applied at the encoder. For example, the decoding engine may, for example, entropy decode coded pixel block data, re-quantize data according to quantization parameters provided in the channel data stream, transform de-quantized pixel block coefficients to pixel data and add predicted video content according motion-compensated prediction techniques. The decoding engine 610 may output recovered video data to a post-processor 620.

The reference picture cache 630 may store decoded video data of pictures identified in the channel data as reference pictures. During operation, the decoding engine 610 may retrieve data from the reference picture cache 630 according to motion vectors provided in the channel data, to develop predicted pixel block data for used in pixel block reconstruction. According to an embodiment of the present invention, a controller 650 may configure a filter 640 according to a mode identifier provided in the channel data to filter the retrieved reference picture data as indicated by the mode identifier. Accordingly, the predicted pixel block data used by a decoding engine 610 should be identical to predicted pixel block data as used by an encoder's coding engine (not shown) during video coding.

The post-processor 620 may perform additional video processing to condition the recovered video data for rendering, commonly at a display device. Typical post-processing operations may include applying deblocking filters, edge detection filters, ringing filters and the like. In an embodiment, a decoder 600 may derive a type of post-processing filter to be applied to recovered video in response to the mode identifier included in the channel. In another embodiment, an encoder 100 (FIG. 1) may include identifiers that specify a type of post-processing filter to be applied to recovered video obtained from the decoding engine. The post-processor 620 may output recovered video sequence that may be rendered on a display device or stored to memory for later retrieval and display.

In an embodiment, channel data may support identification of modes according to a communication protocol exchanged between an encoder and a decoder. An exemplary protocol is illustrated in FIG. 700 in which a mode identification word 700 includes a control flag 710, an optional control field 720, optional data flags 730 and optional data fields 740. A control flag 710 may identify whether a control field is present. In an embodiment, it may be a single bit. In a first state (say, the bit is 1), the control flag 710 may indicate that a mode identifier is present in the bitstream and a control field follows 720. In another state (say, the bit is 0), the control flag 710 may indicate that the mode identifier is not otherwise present in the bitstream. The control field 720 may be a multi-bit code that identifies a type of filtering to be applied. For example, the control field 720 may be provided as a multi-bit vector having a bit position corresponding to each filtering operation supported by the encoder. At each bit position, the state of the bit may indicate whether filtering has been applied. Thus, the control field 720 can indicate that a given reference picture has been subject to multiple kinds of filtering.

The mode identification word 700 further may include one or more data flags 730 corresponding to the number of filtering operations identified in the control field 720. Hypothetically, if two filtering operations were identified in the control field 720, then the mode identification word 700 may include two data flags 730. The state of the data flags may indicate the presence of an accompanying data field 740. In a first state (say, the bit is 1), the data flag 730 may indicate that a data field 740 follows the flag 730. In another state (say, the bit is 0), the control flag 730 may indicate that a data field 740 does not follow. In the case where a filtering operation is identified by the control field 720 but a data field 740 is not provided, a decoder may operate the filter according to pre-coded default operating parameters. If a data field 740 is specified in the bitstream, then the data field 740 may include operating parameters that govern operation of the corresponding filtering operation.

In an embodiment, mode identification words 700 may be provided in the channel bitstream appended to coded video data of each picture. The mode identification words 700 may be provided in an out-of-band protocol such as those established by Session Description Protocols (SDPs).

The foregoing discussion identifies functional blocks that may be used in video coding systems constructed according to various embodiments of the present invention. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. Similarly, video decoders may be provided in mobile or wired devices. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate units. For example, although FIG. 2 illustrates a universal controller 240 that governs operation of the pre-processor 210, the coding engine 220 and filters systems 230, 250-280, the pre-processor 210 control in practice may be a separate component from a coding engine controller, which further may be separate from the filter controller(s). And, further, the filters 250 and 270 need not be provided as separate units. Such implementation details are immaterial to the operation of the present invention unless otherwise noted above.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A video coder comprising:
a reference picture cache to store decoded picture data of previously-coded reference pictures,
a coding engine operable to code input video data according to motion compensated prediction techniques with reference to one or more reference pictures, and
a programmable filter to apply a filtering operation to picture data retrieved from the reference picture cache and provided to the coding engine.

2. The video coder of claim 1, wherein the programmable filter is operable in multiple filter modes, each mode applying a different filtering operation to retrieved picture data.

3. The video coder of claim 1, further comprising a programmable preprocessing filter that applies a filtering operation to a source picture that is input to the coding engine, wherein the programmable filter applies a type of filtering operation to retrieved picture data based on a type of filtering operation applied to the source picture.

4. The video coder of claim 1, wherein the video coder outputs to a channel an identifier of a type of filtering applied to the retrieved picture data.

5. The video coder of claim 1, wherein the reference picture cache stores identifiers of preprocessing operations applied when the respective pictured data was coded.

6. A video decoder comprising:
a reference picture cache to store decoded picture data of previously-decoded reference pictures,
a decoding engine operable to decode input channel data according to motion compensated prediction techniques with reference to one or more reference pictures, and
a programmable filter to apply a filtering operation to picture data retrieved from the reference picture cache and provided to the decoding engine.

7. The video decoder of claim 6, wherein the programmable filter is operable in multiple filter modes, each mode applying a different filtering operation to retrieved picture data.

8. The video decoder of claim 6, wherein the video decoder receives from a channel an identifier of a type of filtering applied to the retrieved picture data and engages the programmable filter in the identified mode.

9. A method of coding video data, comprising:
coding an input picture according to motion compensated prediction techniques with reference to one of a plurality of stored previously-processed reference picture; and
selecting a previously-processed reference picture for the coding by:
comparing a pre-processing operation performed on the input picture with identifiers of pre-processing operations applied to the stored reference pictures,
if a match occurs, identifying the matching stored reference picture(s) as a candidate for prediction, and
selecting a candidate as a reference picture for the coding.

10. The method of claim 9, further comprising, transmitting to a channel the identifier of the pre-processing operation of the selected candidate reference picture.

11. The method of claim 9, further comprising, if there is no match:
applying first filtering operations to a plurality of the stored reference pictures to invert a pre-processing operation stored in association with the respective reference picture,
applying a second filtering operation to the plurality of the stored reference pictures based on the pre-processing operation performed on the input picture,
comparing the filtered reference pictures with the input picture, and
based on the comparison, selecting a candidate as a reference picture for the coding.

12. The method of claim 11, further comprising, transmitting to a channel identifiers of the first and second filtering operations.

13. The method of claim 9, further comprising, if there is no match:
applying a plurality of filtering operations to each of a plurality of the stored reference pictures,
comparing the filtered reference pictures with the input picture, and
based on the comparison, selecting a candidate as a reference picture for the coding.

14. The method of claim 13, further comprising, transmitting to a channel an identifier of a filtering operation performed on the selected candidate reference picture.

15. A method of decoding coded video, comprising:
decoding coded video representing an output picture according to motion compensated prediction techniques with reference to one of a plurality of stored previously-processed reference picture; and
selecting a previously-processed reference picture for the coding by:
retrieving stored reference picture data based on a motion vector, and
filtering the retrieved reference picture data based on a filtering mode identifier contained in the coded video data.

16. The method of claim 15, further comprising performing post-processing on the output picture according to an post-processing identifier contained in channel data.

17. The method of claim 15, further comprising performing post-processing on the output picture according to a type of post-processing operation derived from the filtering mode identifier.

18. The method of claim 15, further comprising displaying the output picture.

19. The method of claim 15, wherein the filtering mode identifies a filtering operation performed at an encoder on a stored reference picture during a motion-compensated predictive coding operation performed to generate the coded video of the output picture.

20. A channel carrying a coded video data signal generated according to a process of:
coding a source video sequence according to motion compensated prediction techniques with reference to one of stored previously-processed reference pictures, wherein,
for an input picture in the source video sequence, the coding comprises retrieving a reference picture from storage and filtering the retrieved reference picture by a filtering operation, and
the filtered reference picture is used as a reference for prediction of the input picture;
coding an identifier of the filtering operation performed on the reference picture; and
outputting to the channel, coded video data of the input picture and the coded filtering identifier.

21. The channel of claim 20, wherein the reference picture is selected by:
comparing a pre-processing operation performed on the input picture with identifiers of pre-processing operations applied to the stored reference pictures,
if a match occurs, identifying the matching stored reference picture(s) as a candidate for prediction, and
selecting a candidate as a reference picture for the coding.

22. The channel of claim 20, wherein the reference picture is selected further by, if there is no match:
applying first filtering operations to a plurality of the stored reference pictures to invert a pre-processing operation stored in association with the respective reference picture,
applying a second filtering operation to the plurality of the stored reference pictures based on the pre-processing operation performed on the input picture,
comparing the filtered reference pictures with the input picture, and
based on the comparison, selecting a candidate as a reference picture for the coding.

23. The channel of claim 20, wherein the reference picture is selected further by, if there is no match:
applying a plurality of filtering operations to each of a plurality of the stored reference pictures,
comparing the filtered reference pictures with the input picture, and
based on the comparison, selecting a candidate as a reference picture for the coding.

24. The channel of claim 20, wherein the coded filtering identifier includes:
a control field identifying type(s) of filtering applied to the reference picture, and
a data flag bit, one corresponding to each identified type of filtering, and
for each data flag in an enabled state, a data field identifying filtering parameters to be applied at a decoder.

25. Channel data, embodied in a physical communication channel, comprising:
coded video data of a source video sequence, the coded video data including coded picture data generated by a motion compensated predictive coding process using reference frames, and
a filtering mode codeword, provided for at least one coded picture, identifying a filtering operation to be performed by a decoder on a reference frame to be used in a motion compensated predictive decoding process.

26. The channel of claim 25, wherein the coded filtering identifier includes:
a control field identifying type(s) of filtering applied to the reference picture, and
a data flag bit, one corresponding to each identified type of filtering, and
for each data flag in an enabled state, a data field identifying filtering parameters to be applied at a decoder.

27. The channel of claim 25, wherein the physical communication channel is a wired communication channel.

28. The channel of claim 25, wherein the physical communication channel is a wireless communication channel.

29. The channel of claim 25, wherein the physical communication channel is a storage medium.
